(19) United States
(12) Patent Application Publication
(10) Pub. No.: US 2025/0309674 A1
(43) Pub. Date: Oct. 2, 2025

(54) POWER MANAGEMENT CIRCUIT

(71) Applicant: Chengdu Monolithic Power Systems Co., Ltd., Chengdu (CN)

(72) Inventor: Bo Li, Chengdu (CN)

(21) Appl. No.: 19/090,165

(22) Filed: Mar. 25, 2025

(30) Foreign Application Priority Data
Mar. 26, 2024 (CN) 202410350637.7

(51) Int. Cl. H02J 7/34; H02J 7/00; H02J 9/06

(52) U.S. Cl. CPC H02J 7/345; H02J 7/0047; H02J 7/0063; H02J 9/06; H02J 2207/50

(57) ABSTRACT

Power management circuit includes a switching circuit, and the switching circuit includes a high-side switch and at least two low-side switches. When the power management circuit operates in a charging mode, some of the low-side switches are enabled, and when the power management circuit operates in a discharging mode, all of the low-side switches are enabled. By selectively enabling all or some of the low-side switches, the current sensing accuracy in the charging mode can be improved while reducing the conduction loss in the discharging mode.

### CROSS-REFERENCE TO RELATED APPLICATIONS

The present application claims priority to, and the benefit of, Chinese application No. 202410350637.7 filed on Mar. 26, 2024, which is incorporated herein by reference in its entirety.

### TECHNICAL FIELD

The present disclosure relates to a power management circuit.

### BACKGROUND

Power management circuit including a power conversion circuit and storage capacitor(s) may have an energy storage function. Generally, the power conversion circuit charges the storage capacitor(s) to have energy stored for example in the form of an energy storage voltage to reach a preset energy storage value so that when a power failure (e.g., power loss or disconnection from the external power source occurs) occurs in the system where the power management circuit is located, the energy stored in the storage capacitor(s) can be used as a backup power supply to provide power.

The power conversion circuit includes a switching circuit, more specifically, the switching circuit includes a plurality of controllable switches. By controlling the ON and OFF states of the plurality of controllable switches in different ways under different conditions, the energy storage capacitor can be charged or discharged. How to improve the current sensing accuracy in the charging mode while reducing the conduction loss in the discharge mode is a problem that needs to be solved.

### SUMMARY

The present disclosure provides a power management circuit having a plurality of switches that can be selected as low-side switches.

The present disclosure provides a power management circuit, which includes an input terminal for receiving an input voltage, a bus terminal for providing a bus voltage and a storage terminal for coupling with a storage capacitor. The power management circuit also includes a switching circuit coupled between a common terminal and the storage terminal. The switching circuit includes a first switch, a second switch and a third switch. The first switch has a first terminal and a second terminal, the first terminal of which is coupled to the common terminal, and the second terminal of which is coupled to the storage terminal. The second switch has a first terminal and a second terminal, the first terminal of which is coupled to the common terminal, and the second terminal of which is grounded. The third switch has a first terminal and a second terminal, the first terminal of which is coupled to the common terminal, and the second end of which is grounded.

The present disclosure provides a power management circuit, which includes an input terminal for receiving an input voltage, a bus terminal for providing a bus voltage and a storage terminal for coupling with a storage capacitor. The power management circuit also includes a switching circuit coupled between a common terminal and the storage terminal. The switching circuit includes a first switch, a second switch, a third switch and a fourth switch. Among them, the first switch has a first end and a second terminal, and its first terminal is coupled to the common terminal, and its second terminal is coupled to the storage terminal. The second switch has a first terminal and a second terminal, and its first terminal is coupled to the common terminal, and its second terminal is grounded. The third switch has a first terminal and a second terminal, and its first terminal is coupled to the common terminal, and its second terminal is grounded. The fourth switch has a first terminal and a second terminal, and its first terminal is coupled to the common terminal, and its second terminal is grounded.

### BRIEF DESCRIPTION OF DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 schematically illustrates a power management circuit 100 in accordance with an embodiment of the present disclosure.

FIG. 2 illustrates a waveform diagram showing waveform of storage voltage of the power management circuit 100 operating in different mode in accordance with an embodiment of the present disclosure.

FIG. 3 schematically illustrates partial circuit of the power management circuit 100 in accordance with an embodiment of the present disclosure.

FIG. 4 illustrates a waveform diagram showing waveform of low-side current of the power management circuit 100 operating in different mode in accordance with an embodiment of the present disclosure.

FIG. 5 schematically illustrates driving logic circuit 106 of the power management circuit 100 in accordance with an embodiment of the present disclosure.

FIG. 6 schematically illustrates a power management circuit 200 in accordance with an embodiment of the present disclosure.

FIG. 7 schematically illustrates driving logic circuit 206 of the power management circuit 200 in accordance with an embodiment of the present disclosure.

The same reference numerals in different schematic figures indicate the same or similar parts or features.

### DETAILED DESCRIPTION

Various embodiments of the present invention will now be described. In the following description, some specific details, such as example circuits and example values for these circuit components, are included to provide a thorough understanding of embodiments. One skilled in the relevant art will recognize, however, that the present invention can be practiced without one or more specific details, or with other methods, components, materials, etc. In other instances, well-known structures, materials, processes or operations are not shown or described in detail to avoid unnecessarily obscuring aspects of the present invention. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example, although it may. Furthermore, the features, structures, or characteristics may be combined in one or more embodiments or examples. In addition, it should be noted that the drawings are provided for illustration and are not necessarily to scale. Throughout the specification and claims, the term “coupled,” as used herein, is defined as directly or indirectly connected in an electrical or non-electrical manner. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element. The terms “a,” “an,” and “the” include plural reference, and the term “in” includes “in” and “on” unless the context clearly dictates otherwise. The term “or” is an inclusive “or” operator, and is equivalent to the term “and/or” herein including “and”, “or” and any combination thereof, unless the context clearly dictates otherwise. Where either a field effect transistor (“FET”) or a bipolar junction transistor (“BJT”) may be employed as an embodiment of a transistor, the scope of the words “gate”, “drain”, and “source” includes “base”, “collector”, and “emitter”, respectively, and vice versa. Those skilled in the art should understand that the meanings of the terms identified above do not necessarily limit the terms, but merely provide illustrative examples for the terms.

The terms “comprise”, “include”, “have” and any variations thereof, are intended to cover non-exclusive inclusions, such that a process, method, article, or apparatus that comprises a list of elements is not necessarily limited to those elements, but may include other elements not expressly listed or inherent to such process, method, article, or apparatus.

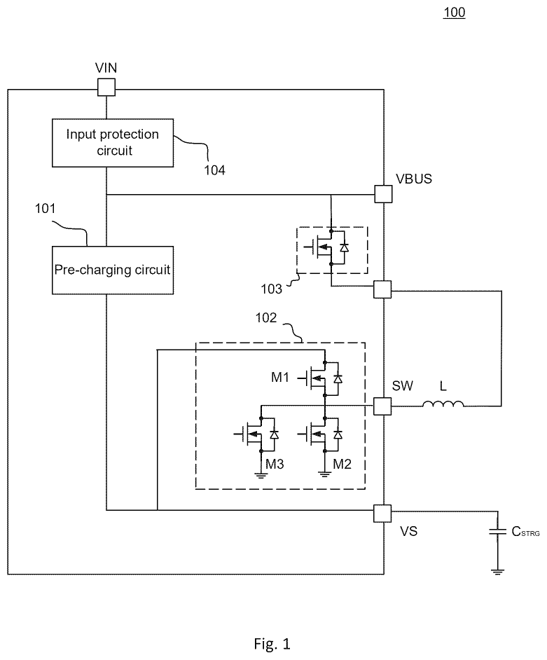

FIG. 1 schematically illustrates a power management circuit 100 in accordance with an embodiment of the present disclosure. The power management circuit 100 may include a bus terminal VBUS that may be adapted to be configured as an output terminal to provide a bus voltage V_bus. The power management circuit 100 may further include a storage terminal VS that may be adapted to be configured as an output terminal, the storage terminal VS having a storage voltage and may be configured to couple to a storage capacitor CSTRG. The power management circuit 100 may further include a switching circuit 102 that may be adapted to be configured to couple between a common terminal SW and the storage terminal VS. The switching circuit 102 may further include a first switch M1, a second switch M2 and a third switch M3. Wherein the first switch M1 is a high-side switch that has a first terminal and a second terminal, the first terminal of the first switch M1 may be adapted to couple to the common terminal SW, and the second terminal of the first switch M1 may be adapted to couple to the storage terminal VS. The second switch M2 is a low-side switch that has a first terminal and a second terminal, the first terminal of the second switch M2 may be adapted to couple to the common terminal SW, and the second terminal of the second switch M2 may be adapted to couple to a ground. The third switch M3 is a low-side switch that has a first terminal and a second terminal, the first terminal of the third switch M3 may be adapted to couple to the common terminal SW, and the second terminal of the third switch M3 may be adapted to couple to a ground. The common terminal SW may be adapted to couple to an inductive element L.

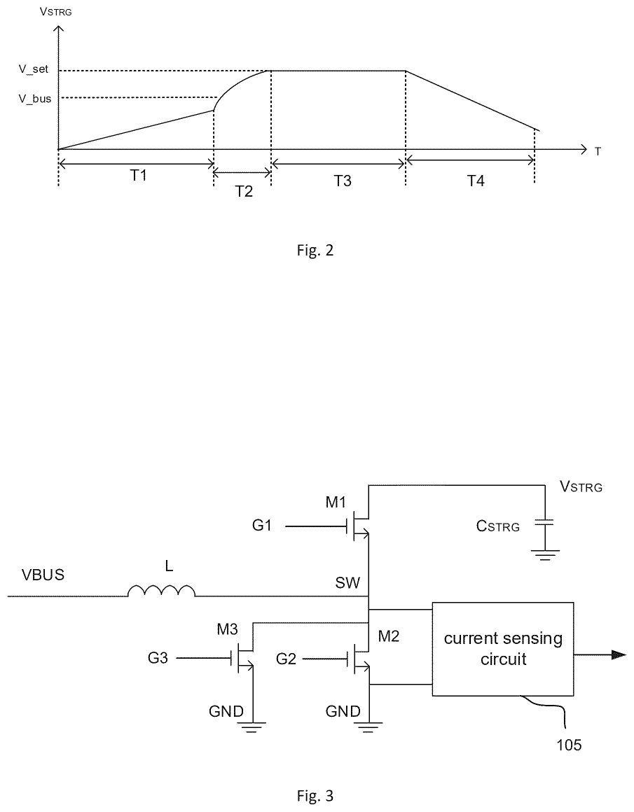

One of the functions of the power management circuit 100 is to provide a current from the bus terminal VBUS to the storage terminal VS to charge the storage capacitor CSTRG. Referring to FIG. 2, during a time period T1, the power management circuit 100 may be adapted to operate in a constant current charging mode, the charging current flows through the pre-charging circuit 101 coupled between the bus terminal VBUS and the storage terminal VS. In the constant current charging mode, the switching circuit 102 may be adapted to be disabled generally. During a time period T2 in an example of FIG. 2, the power management circuit 100 may be adapted to operate in a first boost charging mode, the switching circuit 102 coupled between the bus terminal VBUS and the storage terminal may be adapted to be configured to operate as a boost converter to convert a bus voltage V_bus into a storage voltage VSTRG. As illustratively shown in FIG. 2, in the first boost charging mode, the storage voltage VSTRG may be increased continuously until reaches a storage preset value V_set which is higher than the bus voltage V_BUS. During a time period T3 in an example of FIG. 2, the power management circuit 100 may be adapted to be configured to operate in a second boost charging mode, the switch circuit 102 coupled between the bus terminal VBUS and the storage terminal VS may be adapted to be configured to operate as a boost converter to convert the bus voltage V_bus into the storage voltage VSTRG, and maintain the storage voltage VSTRG at or near to the storage preset value V_set. Herein, “maintain the storage voltage VSTRG at or near to the storage preset value V_set” may refer to controlling the difference between the storage voltage VSTRG and the storage preset value V_set to be within a preset range. Another function of the power management circuit 100 is to enable the storage capacitor CSTRG to be configured to operate as a backup power source when the system occurs power failure. Referring to FIG. 2, during the time period T4, the power management circuit 100 may be adapted to be configured to work in a discharging mode, the switching circuit 102 coupled between the bus terminal VBUS and the storage terminal VS may be adapted to be configured to operate as a buck converter to convert the storage voltage VSTRG into the bus voltage V_bus.

There are various control modes for the switching circuit 102, and common control modes include constant frequency peak current mode control, constant frequency valley current mode control, constant on-time control, and constant off-time control. Among the multiple control modes, there may be a current inner loop including a current sampling feedback circuit, which can quickly respond to changes in the inductor current. In an example of FIG. 3, a first input terminal of a current sensing circuit 105 may be configured to couple to the common terminal SW, the second input terminal of the current sensing circuit 105 may be configured to couple to the ground, and the output terminal of the current sensing circuit 105 may be configured to provide a current sensing signal. The current sensing signal may indicate the current flow through the low-side switch. Since the above control mode may utilize the current sensing signal to implement loop control, improving the current sensing accuracy will contribute to the accuracy of switching circuit control. In alternative exemplary embodiment, the power management circuit 100 may be adapted to configured to include a plurality of branches coupled to the bus voltage V_bus, If the current of the branch where the switch circuit 102 is located can be accurately indicated by the current sensing signal, it will help to implement complex control related to multiple branches.

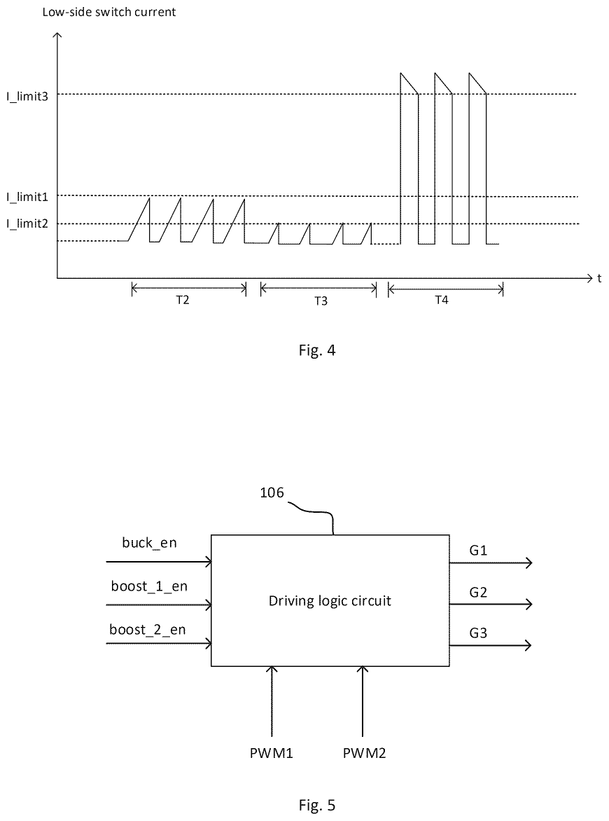

As described above, the switching circuit operates in different ways in the first boost charging mode, the second boost charging mode and the discharging mode. FIG. 4 schematically illustrates a low-side switch current during operate in different modes described above. In an example of FIG. 4, the vertical axis indicates the low-side switch current. Specifically, the physical meaning of the low-side switch current may refer to a total current flowing through multiple low-side switches when the multiple low-side switches are enabled at the same time, and the physical meaning of the low-side switch current may refers to a current flowing through part of the low-side switches when the part of the low-side switches are enabled. Referring to FIG. 4, in the first boost charging mode (i.e., the during the time period T2), the peak value of the low-side switch current may be adapted to be limited by a first current limit value I_limit1. In an alternative embodiment, the first current limit value I_limit1 may be set to 1A, this is just to provide an example and not intended to be limiting. In the second boost charging mode (i.e., during the time period T3), the peak value of the low-side switch current may be adapted to be limited by a second current limit value I_limit2. In an alternative embodiment, the second current limit value I_limit2 may be set to 0.5 A, this is just to provide an example and not intended to be limiting. In the discharging mode (i.e., during the time period T4), the peak value of the low-side switch current may be adapted to be limited by a third current limit value I_limit3. In an alternative embodiment, the third current limit value I_limit3 may be set to 8 A, this is just to provide an example and not intended to be limiting. Although FIG. 4 only qualitatively describes the low-side switch current, it can be seen that in the discharging mode (i.e., during the time period T4), the low-side switch current is significantly greater than the current values in other modes.

In accordance with an exemplary embodiment of the present disclosure, in the first boost charging mode (i.e., the during the time period T2) and the second boost charging mode (i.e., during the time period T3), the second switch M2 may be enabled as the low-side switch to perform ON and OFF switching required for boost power conversion, and the third switch M3 may be disabled, i.e., the third switch M3 is maintained in an OFF state in the above mode. In the discharging mode (i.e., during the time period T4), the second switch M2 and the third switch M3 may be adapted to be enabled as the low-side switch at the same time to perform ON and OFF switching synchronous required for boost power conversion. The beneficial technical effect in described embodiments is that by selectively controlling some or all of the low-side switches to perform ON and OFF switching, different requirements in different operating modes can be met. Specifically, in the boost charging mode, a portion of the multiple low-side switches are enabled, and the equivalent resistance of the enabled portion is larger than the equivalent resistance of enabled all the low-side switches, which can improve the current sensing accuracy. In the discharging mode, all low-side switches are enabled, which can provide greater current conduction capability during the conduction time, helping to reduce the conduction loss of the switching circuit in the discharge mode.

In accordance with an exemplary embodiment of the present disclosure, the power management circuit 100 may further includes a driving logic circuit 106. The driving logic circuit 106 may be adapted to be configured to receive a first boost enable signal boost_1_en, a second boost enable signal boost_2_en, a buck enable signal buck_en, a first duty modulate signal PWM1 and a second duty modulate signal PWM2, and output a first control signal G1 for controlling the first switch M1, a second control signal G2 for controlling the second switch M2, a third control signal G3 for controlling the third switch M3 based on those signal mentioned above.

When the first boost enable signal boost_1_en or the second boost enable signal boost_2_en is in a first logic state (e.g., logic high), and the buck enable signal buck_en is in a second logic state (e.g., logic low), the driving logic circuit 106 may be adapted to be configured to output the first duty modulate signal PWM1 as the first control signal G1, output an inverse signal of the first duty modulate signal PWM1 as the second control signal G2, and output a logic low level signal as the third control signal G3.

When the buck enable signal buck_en is in the first logic state (e.g., logic high), the first boost enable signal boot_1_en and the second boost enable signal boost_2_en are in the second logic state (e.g., logic low), the driving logic circuit 106 may be adapted to configured to output the second duty modulate signal PWM2 as the first control signal G1, output an inverse signal of the second duty modulate signal PWM2 as the second control signal G2 and the third control signal G3.

In accordance with an exemplary embodiment of the present disclosure shown in FIG. 1, the power management circuit 100 may further includes a block transistor 103 coupled between the bus terminal VBUS and the inductive element L. In an embodiment, the block transistor 103 may be configured to couple between the first switch M1 and the storage terminal VS. A body diode of the block transistor 103 and a body diode of the first switch M1 are configured in back-to-back configuration. Herein, the back-to-back configuration of body diodes in two transistors refers to a circuit arrangement where the body diodes (also known as parasitic diodes or intrinsic diodes) of two transistors are connected in opposite directions, i.e., the source terminals of the two transistors are connected together, while their drain terminals are connected to opposite sides of the circuit. In an embodiment, the power management circuit 100 may further include an input terminal VIN configured as an input terminal for receiving input voltage. In an embodiment, the power management circuit 100 may be adapted to be configured to include an input protection circuit 104 coupled between the input terminal VIN and the bus terminal VBUS.

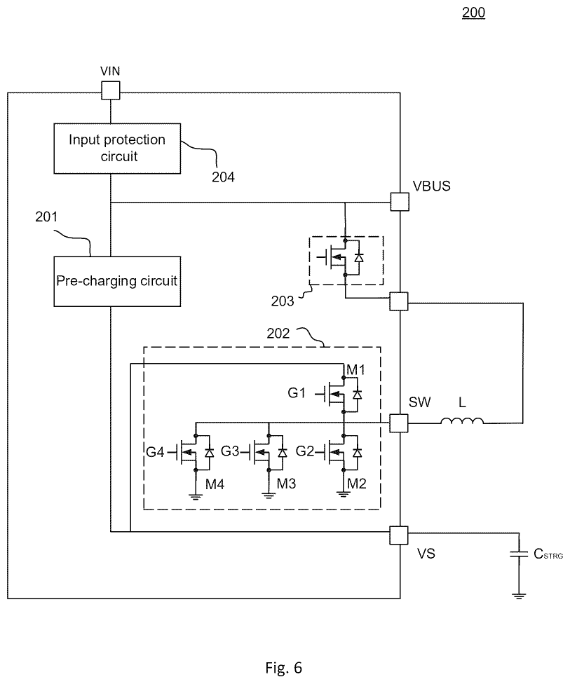

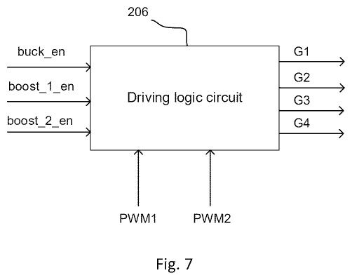

FIG. 6 schematically illustrates a power management circuit 200 in accordance with an embodiment of the present disclosure. One of the ordinary skilled in the art would understand that the power management circuit 200 may be considered as a variant from the power management circuit 100 or may be seen as an exemplary embodiment of the power management circuit 100 with the difference of the switching circuit. The power management circuit 200 may be adapted to be configured to include a switching circuit 202, the switching circuit 202 may be adapted to be configured to include a first switch M1, a second switch M2, a third switch M3 and a fourth switch M4. The first switch M1 may be a high-side switch has a first terminal and a second terminal, the first terminal of the first switch may be configured to couple to the common terminal SW and the second terminal of the first switch may be configured to couple to the storage terminal VS. The second switch M2 may be a low-side switch has a first terminal and a second terminal, the first terminal of the second switch may be configured to couple to the common terminal SW and the second terminal of the second switch may be configured to couple to the ground. The third switch M3 may be a low-side switch has a first terminal and a second terminal, the first terminal of the third switch may be configured to couple to the common terminal SW and the second terminal of the third switch may be configured to couple to the ground. The fourth switch M4 may be a low-side switch has a first terminal and a second terminal, the first terminal of the fourth switch may be configured to couple to the common terminal SW and the second terminal of the fourth switch may be configured to couple to the ground. The common terminal may be configured to couple to the inductive element L.

In accordance with an exemplary embodiment of the present disclosure, in the first boost charging mode (i.e., the during the time period T2), the second switch M2 and the third switch M3 may be enabled as the low-side switch to perform ON and OFF switching required for boost power conversion, and the fourth switch M4 may be disabled, i.e., the fourth switch M4 is maintained in an OFF state in the above mode. In the second boost charging mode (i.e., during the time period T3), the second switch M2 may be enabled as the low-side switch to perform ON and OFF switching required for boost power conversion, and the third switch M3 and the fourth switch M4 may be disabled, i.e., the third switch M3 and the fourth switch M4 are maintained in an OFF state in the above mode. In the discharging mode (i.e., during the time period T4), the second switch M2, the third switch M3 and the fourth switch M4 may be adapted to be enabled as the low-side switch at the same time to perform ON and OFF switching synchronous required for boost power conversion. The beneficial technical effect in described embodiments is that by selectively controlling some or all of the low-side switches to perform ON and OFF switching, different requirements in different operating modes can be met. Specifically, in the boost charging mode, a portion of the multiple low-side switches are enabled, and the equivalent resistance of the enabled portion is larger than the equivalent resistance of enabled all the low-side switches, which can improve the current sensing accuracy. In the discharging mode, all low-side switches are enabled, which can provide greater current conduction capability during the conduction time, helping to reduce the conduction loss of the switching circuit in the discharge mode.

In accordance with an exemplary embodiment of the present disclosure, the power management circuit 200 may further includes a driving logic circuit 206. The driving logic circuit 206 may be adapted to be configured to receive a first boost enable signal boost_1_en, a second boost enable signal boost_2_en, a buck enable signal buck_en, a first duty modulate signal PWM1 and a second duty modulate signal PWM2, and output a first control signal G1 for controlling the first switch M1, a second control signal G2 for controlling the second switch M2, a third control signal G3 for controlling the third switch M3 and a fourth control signal G3 for controlling the fourth switch M4 based on those signal mentioned above.

In accordance with an exemplary embodiment of the present disclosure, the power management circuit 200 may further includes a current sensing circuit 205 (not shown), a first terminal of the current sensing circuit 205 may be configured to couple to the common terminal SW, a second terminal may be configured to couple to the ground and a output terminal may be configured to provide a current sensing signal, the current sensing signal indicates a current flowing on the low-side switch. In an embodiment, as shown in FIG. 6, the power management circuit 200 may further includes a block transistor 203 coupled between the bus terminal VBUS and the inductive element L. In an embodiment, the block transistor 203 may be configured to couple between the first switch M1 and the storage terminal VS. A body diode of the block transistor 203 and a body diode of the first switch M1 are configured in back-to-back configuration. Herein, the back-to-back configuration of body diodes in two transistors refers to a circuit arrangement where the body diodes (also known as parasitic diodes or intrinsic diodes) of two transistors are connected in opposite directions, i.e., the source terminals of the two transistors are connected together, while their drain terminals are connected to opposite sides of the circuit. In an embodiment, the power management circuit 200 may further includes an input terminal VIN configured as an input terminal for receiving input voltage. In an embodiment, the power management circuit 200 may be adapted to be configured to include an input protection circuit 204 coupled between the input terminal VIN and the bus terminal VBUS.

When the first boost enable signal boost_1_en is in a first logic state (e.g., logic high), the second boost enable signal boost_2_en and the buck enable signal buck_en is in a second logic state (e.g., logic low), the driving logic circuit 206 may be adapted to be configured to output the first duty modulate signal PWM1 as the first control signal G1, output an inverse signal of the first duty modulate signal PWM1 as the second control signal G2 and the third control signal G3, and output a logic low level signal as the fourth control signal G4.

When the second boost enable signal boost_2_en is in the first logic state (e.g., logic high), the first boost enable signal boot_1_en and the buck enable signal buck_en are in the second logic state (e.g., logic low), the driving logic circuit 206 may be adapted to configured to output the first duty modulate signal PWM1 as the first control signal G1, output an inverse signal of the first duty modulate signal PWM1 as the second control signal G2, and output a logic low level signal as the third control signal G3 and the fourth control signal G4.

When the buck enable signal buck_en is in the first logic state (e.g., logic high), the first boost enable signal boot_1_en and the second boost enable signal boost_2_en are in the second logic state (e.g., logic low), the driving logic circuit 106 may be adapted to configured to output the second duty modulate signal PWM2 as the first control signal G1, output an inverse signal of the second duty modulate signal PWM2 as the second control signal G2, the third control signal G3 and the fourth control signal G4.

The advantages of the various embodiments of the present invention are not confined to those described above. These and other advantages of the various embodiments of the present invention will become more apparent upon reading the whole detailed descriptions and studying the various figures of the drawings.

From the foregoing, it will be appreciated that specific embodiments of the present invention have been described herein for purposes of illustration, but that various modifications may be made without deviating from the technology. Many of the elements of one embodiment may be combined with other embodiments in addition to or in lieu of the elements of the other embodiments. Accordingly, the present invention is not limited except as by the appended claims.

1. A power management circuit comprising:
an input terminal, configured to receive an input voltage;
a bus terminal, configured to provide a bus voltage;
a storage terminal, having a storage voltage; and
a switching circuit, coupled between a common terminal and the storage terminal; wherein the switching circuit includes:
a first switch, a second switch and a third switch; and wherein
the first switch has a first terminal and a second terminal, the first terminal of the first switch is coupled to the common terminal, the second terminal of the first switch is coupled to the storage terminal;
the second switch has a first terminal and a second terminal, the first terminal of the second switch is coupled to the common terminal, the second terminal of the second switch is coupled to a ground;
the third switch has a first terminal and a second terminal, the first terminal of the third switch is coupled to the common terminal, the second terminal of the third switch is coupled to the ground.

2. The power management circuit of claim 1, wherein the common terminal of the switching circuit is configured to couple to the bus terminal through an inductive element.

3. The power management circuit of claim 1, wherein, in a first boost charging mode and a second boost charging mode, the second switch is enabled to perform ON and OFF switching, and the third switch is disabled.

4. The power management circuit of claim 3, wherein, in the first boost charging mode, the storage voltage at the storage terminal is configured to be increased continuously until reaches or goes higher than a storage preset value;
in the second boost charging mode, the storage voltage is configured to be maintained at or near to the storage preset value.

5. The power management circuit of claim 1, wherein
in a discharging mode, the second switch and the third switch are enabled at the same time.

6. The power management circuit of claim 1, wherein the power management circuit further includes:
a driving logic circuit, configured to receive signals include:
a first boost enable signal, a second boost enable signal, a buck enable signal, a first duty modulate signal and a second duty modulate signal; and output a first control signal for controlling the first switch, a second control signal for controlling the second switch, a third control signal for controlling the third switch based on the signals received.

7. The power management circuit of claim 6, wherein,
when the first boost enable signal or the second boost enable signal is in a first logic state, and the buck enable signal is in a second logic state, the driving logic circuit is configured to output the first duty modulate signal as the first control signal, output an inverse signal of the first duty modulate signal as the second control signal, and output a logic low level signal as the third control signal.

8. The power management circuit of claim 6, wherein,
when the buck enable signal is in a first logic state, the first boost enable signal and the second boost enable signal are in the second logic state, the driving logic circuit is configured to output the second duty modulate signal as the first control signal, output an inverse signal of the second duty modulate signal as the second control signal and the third control signal.

9. A power management circuit comprising:
an input terminal, configured to receive an input voltage;
a bus terminal, configured to provide a bus voltage;
a storage terminal, having a storage voltage; and
a switching circuit, coupled between a common terminal and the storage terminal; wherein the switching circuit includes:
a first switch, a second switch, a third switch and a fourth switch; and wherein the first switch has a first terminal and a second terminal, the first terminal of the first switch is coupled to the common terminal, the second terminal of the first switch is coupled to the storage terminal;
the second switch has a first terminal and a second terminal, the first terminal of the second switch is coupled to the common terminal, the second terminal of the second switch is coupled to a ground;
the third switch has a first terminal and a second terminal, the first terminal of the third switch is coupled to the common terminal, the second terminal of the third switch is coupled to the ground;
the fourth switch has a first terminal and a second terminal, the first terminal of the fourth switch is coupled to the common terminal, the second terminal of the fourth switch is coupled to the ground.

10. The power management circuit of claim 9, wherein the common terminal of the switching circuit is configured to couple to the bus terminal through an inductive element.

11. The power management circuit of claim 9, wherein,
in a first boost charging mode, the second switch and the third switch are enabled at the same time, and the fourth switch is disabled.

12. The power management circuit of claim 11, wherein, in the first boost charging mode, a storage voltage on the storage terminal is configured to be increased continuously until reaches or goes higher than a storage preset value.

13. The power management circuit of claim 9, wherein, in a second boost charging mode, the second switch is enabled, the third switch and the fourth switch are disabled.

14. The power management circuit of claim 13, wherein,
in the second boost charging mode, the storage voltage is configured to be maintained at or near to the storage preset value.

15. The power management circuit of claim 9, wherein,
in a discharging mode, the second switch, the third switch and the fourth switch are enabled at the same time.

16. The power management circuit of claim 1, wherein the power management circuit further includes:
a driving logic circuit, configured to receive signals include:
a first boost enable signal, a second boost enable signal, a buck enable signal, a first duty modulate signal and a second duty modulate signal; and output a first control signal for controlling the first switch, a second control signal for controlling the second switch, a third control signal for controlling the third switch and a fourth control signal for controlling the fourth switch based on the signals received.

17. The power management circuit of claim 16, wherein when the first boost enable signal is in a first logic state, the second boost enable signal and the buck enable signal are in a second logic state, the driving logic circuit is configured to output the first duty modulate signal as the first control signal, output an inverse signal of the first duty modulate signal as the second control signal and the third control signal, and output a logic low level signal as the fourth control signal.

18. The power management circuit of claim 16, wherein when the second boost enable signal is in a first logic state, the first boost enable signal and the buck enable signal are in a second logic state, the driving logic circuit is configured to output the first duty modulate signal as the first control signal, output an inverse signal of the first duty modulate signal as the second control signal, and output a logic low level signal as the third control signal and the fourth control signal.

19. The power management circuit of claim 16, wherein, when the buck enable signal is in a first logic state, the first boost enable signal and the second boost enable signal are in the second logic state, the driving logic circuit is configured to output the second duty modulate signal as the first control signal, output an inverse signal of the second duty modulate signal as the second control signal, the third control signal and the fourth control signal.
